(19) United States
(12) Patent Application Publication
(10) Pub. No.: US 2019/0148079 A1
(43) Pub. Date: May 16, 2019

(54) SOLID STATE ENERGY STORAGE DEVICE AND METHOD OF FABRICATION

(71) Applicant: Blue Horizons Innovations,LLC, Coconut Creek, FL (US)

(72) Inventor: David L. Frank, Highland Beach, FL (US)

(21) Appl. No.: 16/248,182

(22) Filed: Jan. 15, 2019

Related U.S. Application Data
(63) Continuation-in-part of application No. 15/660,613, filed on Jul. 26, 2017.
(60) Provisional application No. 62/617,671, filed on Jan. 16, 2018.

(51) Int. Cl. H01G 9/00; H01G 9/048; H01G 9/15

(52) U.S. Cl. CPC H01G 9/0036; H01G 9/048; H01G 9/042; H01G 9/15; H01G 9/0003

(57) ABSTRACT

An advanced multilayer ceramic capacitor (SSEE) and an improved method of production of a Solid-State Energy Element using inkjet material deposition and specialized inks.

### CROSS-REFERENCES TO RELATED APPLICATION

This application is based upon and claims priority to U.S. patent application Ser. No. 62/617,671, filed on Jan. 16, 2018, and is a continuation-in-part of pending U.S. patent application Ser. No. 15/660,613, filed on Jul. 26, 2017; the entire collective disclosure thereof being hereby incorporated by reference herein.

### BACKGROUND

The patent relates to solid state electrolytes and a method of fabrication that provides a multilayer stack of solid state electrolytes interleaved in between electrodes forming a solid state energy storage device. Inkjet material deposition is applied to simplify production and improve energy density.

The present disclosure generally relates to energy storage devices that are based on ultra-thin layers of solid state electrolyte(s) and electrode materials that are fabricated through inkjet material deposition.

Current battery and rechargeable battery technologies do not lend themselves to a broad range of applications. Large and heavy batteries are applied to electric vehicles and contribute a significant portion of the weight of the vehicle to enable driving range. Miniature batteries have been developed in recent years to address miniature sensors and actuators such as biomedical devices and wireless communication systems.

In the middle are requirements for portable electronic devices such as cellphones and computers. Chemical battery technologies have limited numbers of charge cycles before degradation of the battery charge capacity and are limited to 4 volts or less per cell.

The need to eliminate the hazards of explosions with lithium based batteries and the need for rapid recharge cycles and an extended number of recharge cycles is leading towards solid electrolytes for battery technologies.

However, solid electrolytes do not provide the ion transport efficiency of liquid electrolytes resulting in reduced energy density.

Many important applications demand high energy density, high operating voltage per cell and an extended battery life-cycle.

Therefore a need exists to overcome the limitation of solid electrolytes with the prior art as discussed above.

### BRIEF SUMMARY

A Solid State Energy Element (SSEE) provides solid state electrolyte material interleaved in between electrodes (cathodes and anodes). The electrolyte and electrode layers are formed as ultra-thin layers with complex patterns. The ultra-thin layers and complex patterns are produced using precursor materials that are modified to have ink-like characteristics and are used in an inkjet material deposition system. The material deposition system creates a multilayer thin film (MLTF) that can be heat processed or pressure processed to form a Solid State Energy Element.

The Solid State Energy Element is fabricated using our inkjet deposition system and proprietary inks enhances ion transport based on a shorter transport distance across the ultra-thin solid state electrolyte between the anode and cathode. This results in an increased number of ions that successfully transport between the anode and cathode.

The Solid State Energy Element (SSEE) fabricated using our inkjet deposition system allows for complex layer patterns within the SSEE and an ability to create stack of electrolytic and electrode layers in series, parallel and combined series parallel connections between the electrodes within the SSEE.

Multiple SSEEs can be combined in series, parallel or combined series parallel connections to form a Solid State Energy Cell (SSEC). Multiple SSECs can be combined in series, parallel or combined series parallel connections to form a Solid State Energy Module (SSEM). Multiple SSEMs can be combined in series, parallel or combined series parallel connections to form a Solid State Energy Array (SSEA).

The Solid State Energy Element (SSEE) provides rapid charge, over 100,000 recharge cycles, operating voltages of up to 10 volts per cell and can be manufactured at a low cost. The SSEE utilizes Precursor or Nano Ink that is deposited to form each layer.

The SSEE design addresses the seven critical issues in battery technology:

Significant Increase in Energy Density

Ability to provide SSEE and SSEC operating voltages of 10v or more

Reduced number of cells for energy storage applications

Reduced size and weight

Reduced cost

No Hazardous Materials

Rapid Recharge Capability

Long Battery Life-Cycle: The SSEE is based on a solid state electrolyte that can provide hundreds of thousands of recharges without impact.

Reduced Price

The transformational inventions for the SSEE include a proprietary design enabling the capabilities listed above and proprietary fabrication methods that provide for volume production of the SSEE at low cost.

Super-Ionic Conductor (SIC) materials are used as electrolytes in electro-chemical battery technologies. Only a few materials offer effective ionic conductivity for battery energy storage. Even fewer SIC materials can operate efficiently at or near room temperature.

Liquid electrolytes can be highly efficient ionic conductors with better efficiency for ion transport compared to solid state electrolytes. The ultra-thin solid electrolyte layer within the SSEE addresses the need for an improved ion transport across a solid electrolyte.

A solid state electrolyte possesses a structure that enables conducive to ionic mobility. There are few solids that enable ionic mobility at room temperature. It is known that Sodium for example has good ion mobility in β-alumina. Solids having exceptionally high ionic conductivity are called fast ion conductors, superionic conductors or solid electrolytes. The solid electrolytes have special crystal structures where open tunnels enable ions transport.

Rechargeable batteries or secondary batteries, such as Li-ion batteries, Na-ion batteries, and Mg-ion batteries, reversibly convert between electrical and chemical energy via redox reactions, storing energy as chemical potential in their electrodes.

The energy density of a rechargeable battery is determined collectively by the specific capacity of electrodes and the working voltage of the cell. The working voltage of the cell is defined as the differential in potential between the cathode and the anode. A higher-potential cathode and a lower-potential anode can be used to increase battery cell voltage.

The electrode materials must offer a large reversible storage capacity. The number of electrons is correlated with the number of ions accommodated in the host lattice. However, in practice, a significantly lower capacity is realized as only a portion of the ions can be reversibly inserted into or extracted from the host.

The site energy of ions and the band energy state of electrons are two main factors that determine the voltage profiles of materials. The optimum materials for the design of new electrode materials are described as Li, Na, Mg, Ti, Mn, Fe, Cu, B, C, N, O F, Si, P, S, Sb, Sn, Nb, Mo, Al, LiTiO, Bi, and W with other materials in development.

The SSEE and SSEC is designed as a scalable product supporting micro-battery applications, mobile devices, fixed energy backup, grid energy storage, alternative energy storage and large arrays for commercial, utility and government applications.

Inkjet printing provides a material deposition process that can provide ultra-thin layers in specific patterns with one or more materials applied in patterns for each layer.

The present invention enables the fabrication of a Solid State Energy Storage Element that has one or more solid state electrolytic layers comprised of a plurality of precursor materials and or Nano particles that form layers of less than 10 microns thick. The electrolytic layers are interleaved in between electrode layers to form a multi-layer thin film (MLTF). One or more multilayer thin films are applied to form a Solid State Energy Element (SSEE)

The present invention describes a Solid State Energy Storage Element comprised of solid state electrolyte layers interleaved in between electrode layers which are fabricated using inkjet material deposition. The inkjet material deposition allows for complex patterns of one or more materials within the same layer. Inkjet material deposition also enables one or more layer types and patterns such as dielectric layers, electrode layers, cathode layers, anode layers, and insulator layers. The inkjet material deposition processes and specialized inks allow ultra-thin layers of complex patterns from one to thousands of layers.

The use of inkjet deposition and complex patterns simplifies manufacturing and enables ultra-thin layers of less than one micron which improves ion transport and overall energy density

Layer Type: Electrode Layer (Cathode)

There are a wide variety of materials that can be applied as the cathode layer. The voltage differential between the cathode and anode are important factors to ensure high operating voltage. The anode material selected requires a high energy content such as is found in alkali metals.

One of the conductive Ink types for the anode layer is graphene. Graphene is a two-dimensional sheet of carbon atoms, just one atom thick. One method of preparing graphene ink is to suspend nanoparticles of graphene in a carrier mixture which is modified to ensure proper viscosity, wetting, ink drop formation and surface tension.

3D printing graphene uses a moderate viscosity (25-35 Pa·s) graphene suspension comprised of graphene with a polymer binder in a mixture of solvents that can be 3D printed. 3D graphene conductive networks provide short path length for Li ion and electron transport. Integration of graphene and alloying type active materials improve electrode performance.

A number of promising 3D graphene-based hybrid anodes ranging from sheet-like, core-shaped, to foam-like morphologies are discussed. In the formation of the multilayer thin film, the electrolyte material can infuse into a portion of the graphene anode prior to and during heat treatment of the MLTF.

A variety of materials can be combined with the graphene to create high performance alloys.

An insulating material may be applied to the edges of the electrode layer.

Layer Type: Electrode Layer (Anode)

There are a wide variety of materials that can be applied as the Anode layer. The voltage differential between the cathode and anode are important factors to ensure high operating voltage. The general requirements for selection for anode materials include:

low first cycle irreversible loss

high coulombic efficiency

fast ion diffusion into and out of the anode

high ionic and electronic conductivity

minimum structural changes upon charge and discharge

high specific capacity

maintain a stable electrolyte interface.

One of the conductive Ink types for the anode layer is graphene. Graphene is a two-dimensional sheet of carbon atoms, just one atom thick. One method of preparing graphene ink is to suspend nanoparticles of graphene in a carrier mixture which is modified to ensure proper viscosity, wetting, ink drop formation and surface tension.

3D printing graphene uses a moderate viscosity (25-35 Pa·s) graphene suspension comprised of graphene with a polymer binder in a mixture of solvents that can be 3D printed. 3D graphene conductive networks provide short path length for Li ion and electron transport. Integration of graphene and alloying type active materials improve electrode performance.

A number of promising 3D graphene-based hybrid anodes ranging from sheet-like, core-shaped, to foam-like morphologies are discussed. In the formation of the multilayer thin film, the electrolyte material can infuse into a portion of the graphene anode prior to and during heat treatment of the MLTF.

A variety of materials can be combined with the graphene to create high performance alloys.

An insulating material may be applied to the edges of the electrode layer.

Another conductive Ink type for the anode is comprised of a Nickel precursor that is stable at room temperature. The Nickel precursor has a metal ion that can be reduced to a pure metallic state by a reducing agent and heat. The reducing agent and nickel precursor are activated in the temperature in the range of 100-300° C. The reaction of the nickel precursor, reduction agent and heat forms pure metal deposit.

The nickel precursor and reduction agent can be formulated into a Nano-Ink where the nickel precursor and reducing agent are loaded into a carrier fluid for use in a variety of print processes including inkjet printing, spray deposition and or screen printing.

Layer Type: Solid State Electrolyte (Superionic Conductors)

Superionic conductors are solids with highly mobile ions. As solid electrolytes they allow the movement of ions without the need for a liquid or soft membrane separating the electrodes. The phenomenon relies on the hopping of ions through a rigid crystal structure.

Superionic conductors are those solid materials which allow movement of ions through their structure. Typically this occurs at an elevated temperature.

Sodium Ion

Sodium-ion batteries are emerging as candidates for large-scale energy storage due to their low cost and the wide variety of cathode materials available. One such design is based on Na₁₀SnP₂S₁₂, with room temperature ionic conductivity of 0.4 mS cm⁻¹. Variants of this compound include a tin is substituted silicon to achieve even higher conductivity.

Solid state sodium-ion batteries are promising candidates for large-scale energy storage applications. A solid state sodium electrolyte exhibits high Na+ conductivity at ambient temperatures, as well as excellent phase and electrochemical stability.

Using an inkjet print deposition process enables an ultra-thin electrolyte layer to increase successful ion transport.

Another variant for sodium electrolyte is Cl-doped Na3PS4 (t-Na3-xPS4-xClx) with a room-temperature Na+ conductivity exceeding 1 mS cm−1. Another includes Na₃SbS₄.

Layer Type: Insulating Layer

Insulating Layer: The insulator layer ink may be comprised of a variety of materials with resistivity of 10⁸ ohms per square centimeter or greater. The insulator materials can be oxides or other insulator materials with lower temperature curing.

Layer Type: Outside Cover

The top and bottom cover layers for the SSEE is an insulating material that encases the SSEE with the exception of the left and right electrodes.

A multi-layer thin film is created by applying the inks described above. The multi-layer thin film is heat treated to form a SSEE device.

In FIG. 1 we illustrate a multilayer capacitor.

In FIG. 2 we illustrate example complex patterns deposited by inkjet material deposition to form the layers of f SSEE.

In FIG. 3 we illustrate the conventional SSEE fabrication processes (301) that are replaced with inkjet material deposition (302).

### BRIEF DESCRIPTION OF THE DRAWINGS

The accompanying figures in which like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1: Describes a Multilayer Solid State Electrolyte Stack (SSEES)

FIG. 2: An Example of Complex Patterns Applied to S SEES Layers

FIG. 3. Illustration of types of electrodes and stack configurations

FIG. 4: Illustrates the x, y, z axis

FIG. 5: Drop and Spread and Evaporation of Nanoparticle Ink

FIG. 6: Illustration of an Inkjet Drop pattern

FIG. 7: Illustrated a composite material at the deposition layer in inkjet printing

FIG. 8: illustrates a Nanoparticle Deposition Frame Structure

FIG. 9: Inkjet Compound Material Deposition Flow Chart

FIG. 10: Describes the Material Deposition System

FIG. 11 Material Deposition Process for the SSEE Layers

FIG. 12 Describes the Process to Print an SSE Multilayer Thin Film

FIG. 13 Describes the Heat Process to Fabricate an SSE Element Thin Film

### DETAILED DESCRIPTION

As required, detailed embodiments are disclosed herein; however, it is to be understood that the disclosed embodiments are merely examples and that the devices, systems and methods described herein can be embodied in various forms. Therefore, specific structural and functional details disclosed herein are not to be interpreted as limiting, but merely as a basis for the claims and as a representative basis for teaching one of ordinary skill in the art to variously employ the disclosed subject matter in virtually any proprietary detailed structure and function. Further, the terms and phrases used herein are not intended to be limiting, but rather, to provide an understandable description. Additionally, unless otherwise specifically expressed or clearly understood from the context of use, a term as used herein describes the singular and/or the plural of that term.

The terms “a” or “an”, as used herein, are defined as one or more than one. The term “plurality”, as used herein, is defined as two or more than two. The term “another”, as used herein, is defined as at least a second or more. The terms “including” and “having,” as used herein, are defined as comprising i.e., open language. The term “coupled,” as used herein, is defined as “connected,” although not necessarily directly, and not necessarily mechanically. “Communicatively coupled” refers to coupling of components such that these components are able to communicate with one another through, for example, wired, wireless or other communications media. The term “communicatively coupled” or “communicatively coupling” includes, but is not limited to, communicating electronic control signals by which one element may direct or control another. The term “configured to” describes hardware, software or a combination of hardware and software that is adapted to, set up, arranged, commanded, altered, modified, built, composed, constructed, designed, or that has any combination of these characteristics to carry out a given function. The term “adapted to” describes hardware, software or a combination of hardware and software that is capable of, able to accommodate, to make, or that is suitable to carry out a given function.

The terms “controller”, “computer”, “server”, “client”, “computer system”, “computing system”, “personal computing system”, or “processing system” describe examples of a suitably configured processing system adapted to implement one or more embodiments of the present disclosure. Any suitably configured processing system is similarly able to be used by embodiments of the present disclosure. A processing system may include one or more processing systems or processors. A processing system can be realized in a centralized fashion in one processing system or in a distributed fashion where different elements are spread across several interconnected processing systems.

The terms “computing system”, “computer system”, and “personal computing system”, describe a processing system that includes a user interface and which is suitably configured and adapted to implement one or more embodiments of the present disclosure. The terms “network”, “computer network”, “computing network”, and “communication network”, describe examples of a collection of computers and devices interconnected by communications channels that facilitate communications among users and allows users to share resources. The terms “wireless network”, “wireless communication network”, and “wireless communication system”, similarly describe a network and system that communicatively couples computers and devices primarily or entirely by wireless communication media. The terms “wired network” and “wired communication network” similarly describe a network that communicatively couples computers and devices primarily or entirely by wired communication media.

In one embodiment, we propose a Multilayer Solid State Electrolyte Stack (SSEE) Element that is fabricated using inkjet material deposition forming complex patterns from dielectric, electrode and insulator materials. The inkjet material deposition also enables ultra thin layers with the SSEE improving overall SSEE energy density.

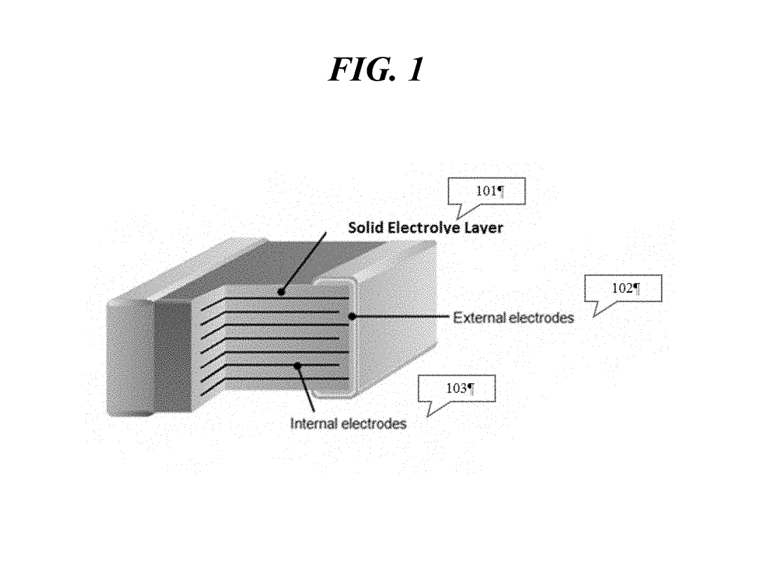

FIG. 1 illustrates the solid state electrolyte layer (101), inner electrodes (102) and external electrodes (103) design for the SSEE Device.

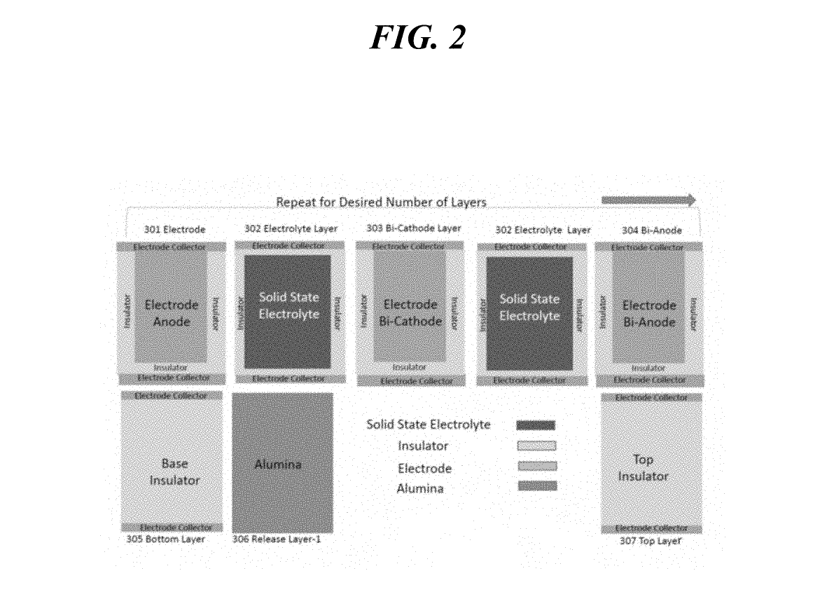

FIG. 2 illustrates example print patterns for an SSEE device Element that applies an encapsulated dielectric energy storage layer.

Where the inner electrodes (201 and 203) are smaller in width and length than the dielectric layer to avoid contact with other electrodes, except where connected to an electrode array collector that forms an outer electrode, and

Where insulator material is applied to the outer edges of each left and right electrodes (201 and 203), except where connected to the collector (210 and 210), to avoid potential interaction between the left and right electrodes and to eliminate an electrical path between dielectric layers (202 and 203) , and

Where the inner left (201) and inner right inner (203) electrodes are each combined into a left (210) and right (210) collector that forms the outer left and right electrode.

The inner electrodes alternate as right and left inner electrodes.

The dielectric energy storage layers (202) are encapsulated by insulator material.

The insulator layer may be comprised of a variety of materials with various temperatures for heat processing.

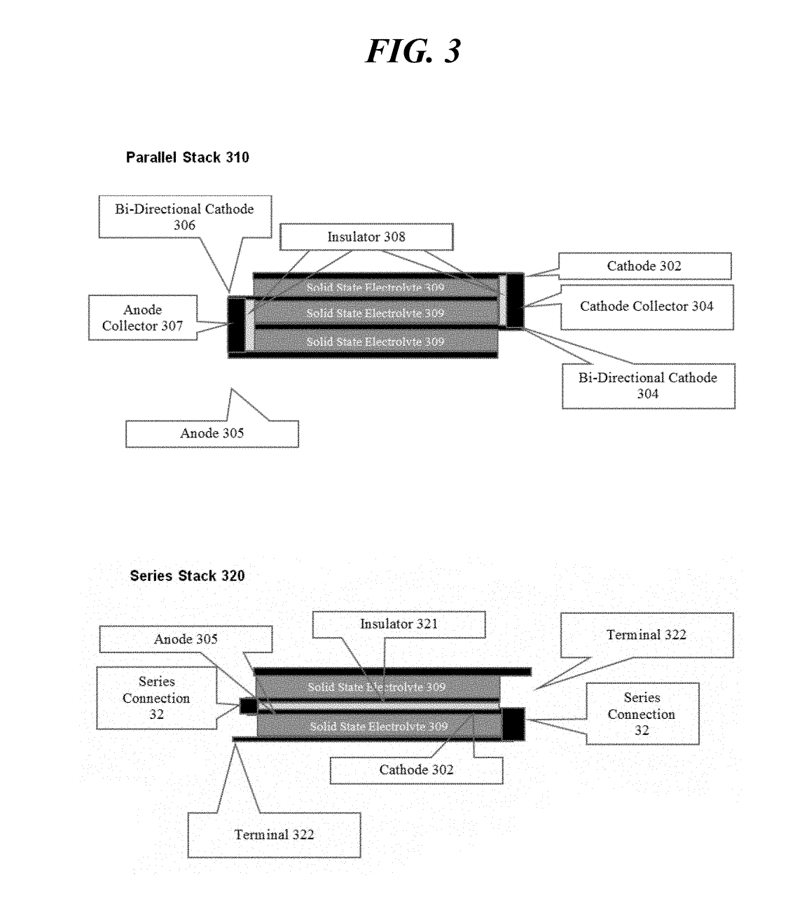

FIG. 3 illustrates the difference between anodes (301), cathodes (311) and bidirectional anodes (302) and bidirectional cathodes (312). FIG. 3 also illustrates parallel (310) and series (320) stack configurations. A Multilayer Solid State Electrolyte Stack may be configured as a parallel stack, a series stack or a combination of parallel and series stacks.

Novel InkJet Print Methods

Inkjet printing is used to deposit the layers of the SSEE Thin Film. Particles and or precursor material are used for the fabrication of the SSEE layers. In some cases, composite materials are applied using two or more print heads to create a composite at the printed layer.

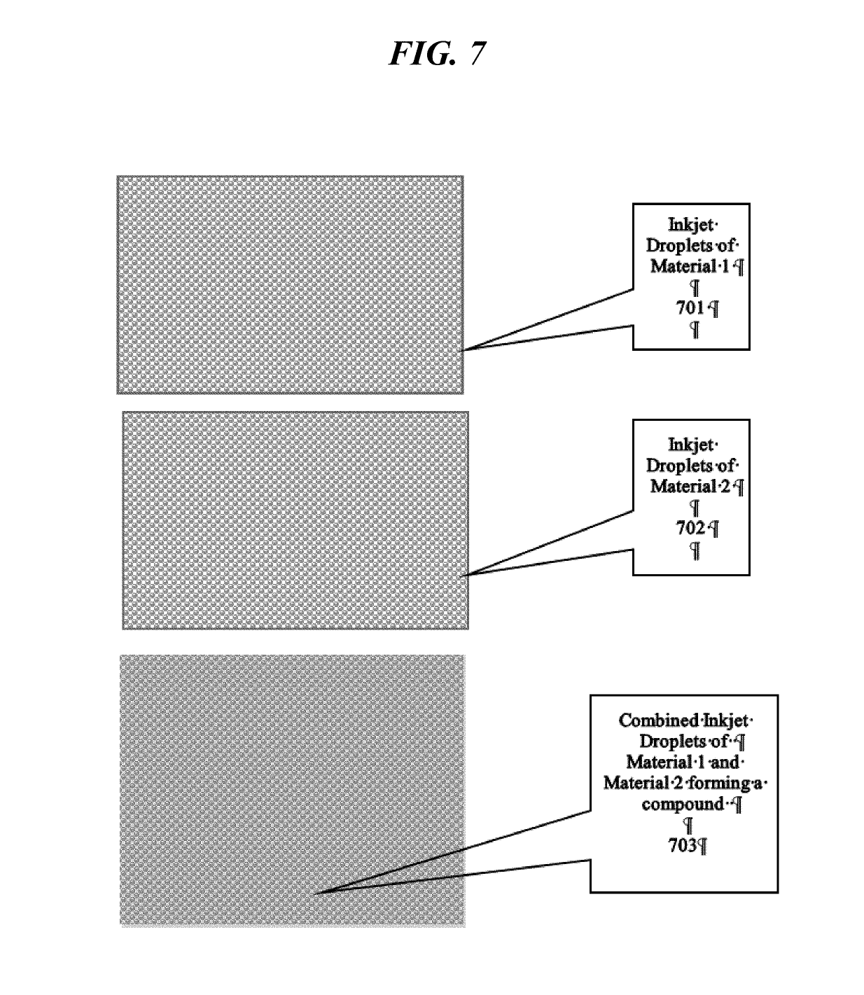

In FIG. 7, we illustrate the printing of two individual types of materials in inkjet droplets (702, 702) and the combined materials as composite in 703). The different materials are mixed to create a uniform composite of the two or more materials deposited.

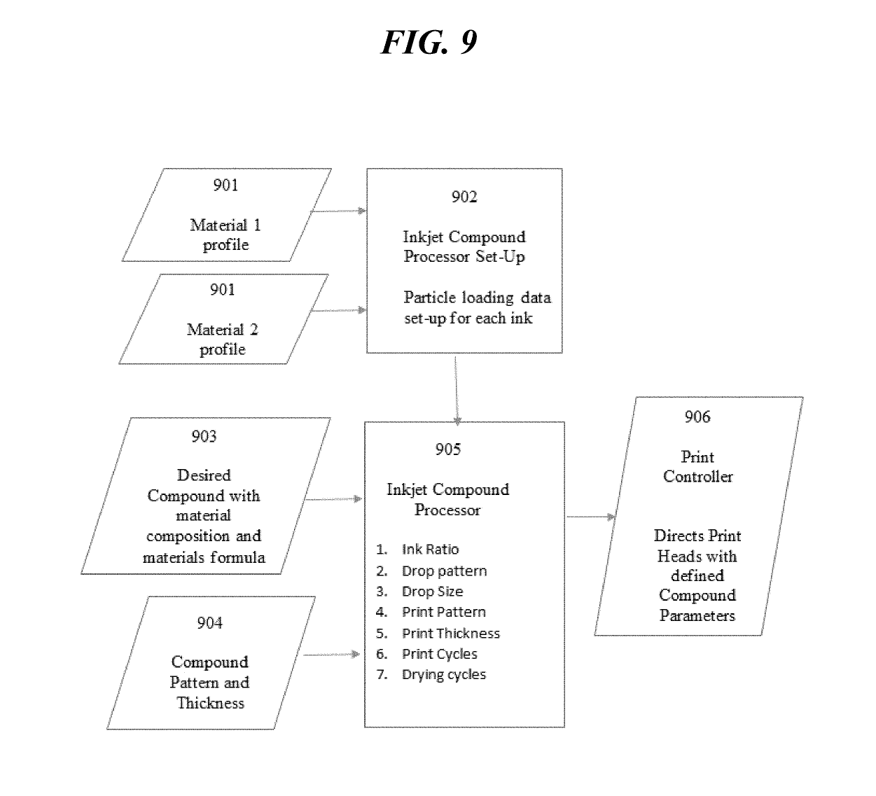

In FIG. 9, a computer device (902) compiles the inkjet compound set-up (902) derived from the particle loading data (901) for each deposition material (ink) profile.

One or more materials are combined to form an ink and where two or more inks are deposited into the same layer by two or more spray or drop on demand devices into the same deposition layer to form a compound. The inkjet processor (905) identifies the ink ratio, drop pattern, drop size, print pattern, print thickness, number of print cycles and drying cycles for the print operation and send this data to the print controller (906) to drive the printer and produce the desired printed pattern.

The proportions of the one or more material inks are deposited as spray droplets configured to achieve a composite material desired stoichiometric formula.

Consecutive independent layers may be printed on top of existing layers as single material layers and or composite material layers. One or more layers may be deposited to create a single layer and or multilayer device.

The print process may incorporate one or more single ink print layers and one or more multi-ink composite print layers in any configuration, and

A computer device can calculate the amount and dispersion method for each material to be deposited to form the desired composite layers, and

The inkjet deposition method described above can be used to fabricate an electronic circuit comprised of single and multilayer devices, electronic devices, circuit patterns, a battery, capacitor and or an energy storage capacitor.

Electrolyte Material inks

Electrolyte materials include any and all dielectric materials that can be applied to a solid state electrolyte battery. Superionic conductors are types of materials that provide excellent performance as an electrolyte material.

Superionic conductors are solids with highly mobile ions. As solid electrolytes they allow the movement of ions without the need for a liquid or soft membrane separating the electrodes. The phenomenon relies on the hopping of ions through a rigid crystal structure.

Superionic conductors are those solid materials which allow movement of ions through their structure. Typically this occurs at an elevated temperature.

Inkjet Deposition

In one embodiment, the present invention applied the mixing of materials during the material deposition process to create a compound using a spray and or drop-on-demand ink jet printing apparatus. The inkjet deposition system would position the print heads across a two or three dimensional axis with an optional ability to rotate print head alignment to enable the stacking of two dimensional nanoparticle patterned layers to form a three dimensional electronic device.

The use of two or more print heads to mix two materials becomes important when the two materials are in compatible in a single solution. For example: In some instances the pH level of a solution enables particle distribution, which is an important characteristic for inkjet ink passing through an inkjet printer (material deposition system). The pH of two solutions may need to be different to suspend the different materials that would comprise the desired compound material to be deposited in a single layer. In this case, and others, the use of multiple different solutions may be desirable. After the ink (particle solution) has passed through the inkjet head, the particle suspension is less critical. Therefore, the mixing of the two solutions by multiple deposition print heads is a solution to this problem.

The inkjet deposition process for mixing at the deposition layer is as follows:

Define the chemical composition of the layer to be deposited.

Define the stoichiometric values for each chemical in the compound and define the ratio of each chemical in the compound.

Define which chemicals are compatible to be combined in an ink for inkjet deposition, identify the compatible chemicals as chemical groups to be combined into an ink solution.

If there are two or more chemical groups, then we need to determine the chemical and or particle loading of each ink.

Based on the chemical and or particle loading of each ink and the ratio of the chemicals to be applied at the deposition layer to create the desired compound, we create a material Deposition Profile (MDP).

The MDP is a ratio of each ink to be applied at the deposition layer, taking into account:

The original chemical stoichiometric formula

The particle loading of each ink to be applied.

The combination of the inks to be deposited to achieve the stoichiometric value for the compound mixture.

Selection of the print drop-on-demand process for deposition, which may include layer on layer, interlacing of ink drops, random placement of ink drops and the placement of ink drops in specific patterns.

The Raster Image Software (RIP) and or ICC Software are modified to reflect chemical composition instead of colors.

A raster image processor (RIP) is a component used in the printing industry which produces a raster image also known as a bitmap. The RIP image is used to generate the patterns to be printed.

In the printing industry colors have been defined by the International Color Consortium (ICC). The ICC color profiles are a set of data that describes the properties of a color space, the range of colors (gamut) that a monitor can display or a printer can output.

In the proposed material deposition system the RIP software would be used to define patterns for the material deposition. As opposed to the ICC profiles, for the mixing of multiple materials within the defined pattern, we apply chemical formulas for the deposition ratio of the multiple materials. The formula takes into consideration the particle loading representing the material within the ink to be deposited, the ratio of the two or more inks to be deposited into the mixed layer and the pattern selected for each material ink. This formula created by a mixture of the materials deposited by print heads is called the material Deposition Profile (MDP).

Multiple print methods may be applied for mixing the multiple materials. These include but are not limited to print matrix interlacing, specific patterns and multilayer deposition.

A three dimension coordinate system is defined as a Cartesian coordinate system with an ordered triplet of lines (axes) that are pair-wise perpendicular, have a single unit of length for all three axes and have an orientation for each axis. As in the two-dimensional case, each axis becomes a number line. The coordinates of a point P are obtained by drawing a line through P perpendicular to each coordinate axis, and reading the points where these lines meet the axes as three numbers of these number lines.

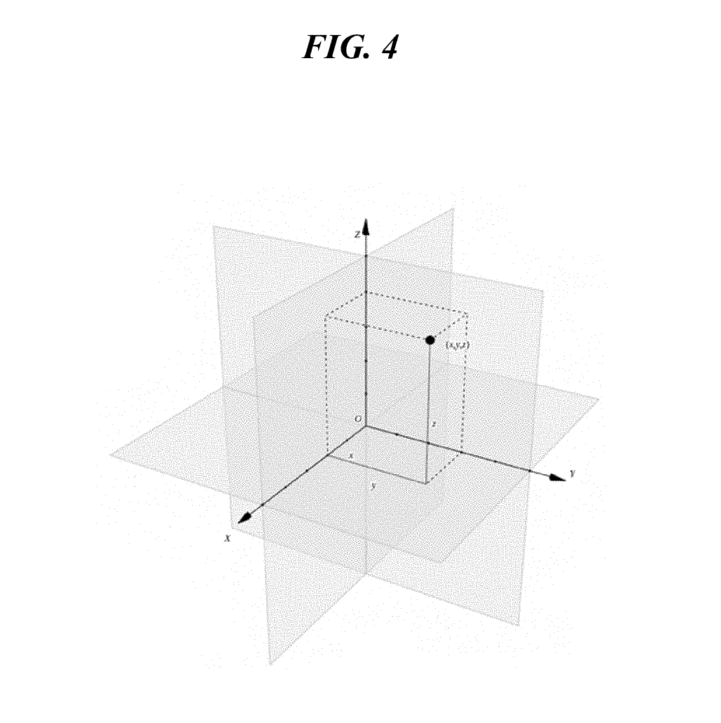

In FIG. 4 will illustrate a three dimensional Cartesian coordinate system, with origin O and axis lines X, Y and Z, oriented as shown by the arrows. The tick marks on the axes are one length unit apart. The black dot shows the point with coordinates x=2, y =3, and z=4, or (2, 3, 4).

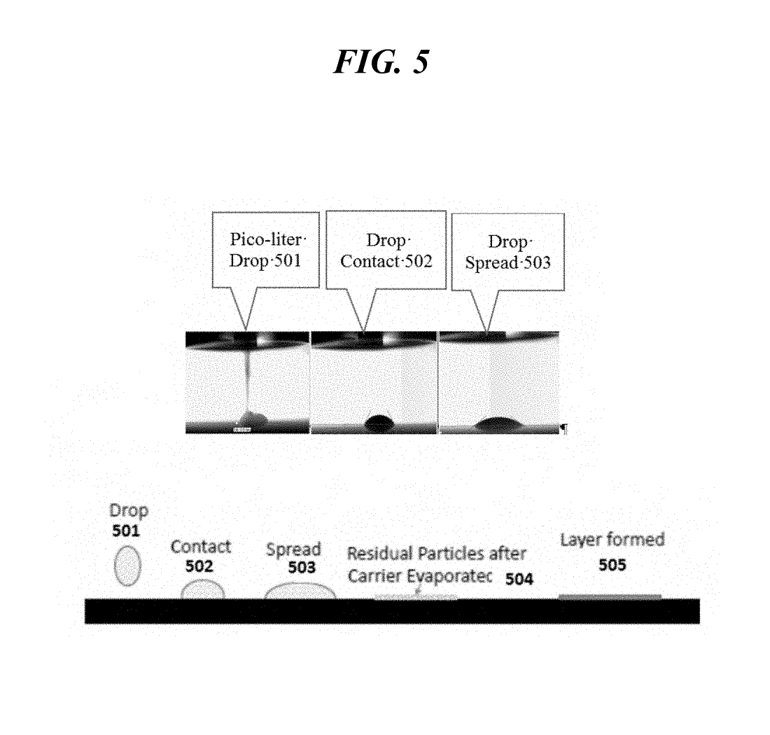

As shown in FIG. 5, the deposition head deposits Nano Ink onto a substrate or an existing layer. The drop on demand process positions Nano Ink with suspended Nanoparticles in a pattern.

Depending on the size of the Nano Ink droplet (501) and the tension of the Nano-Ink and substrate, the droplet impacts (502) the substrate or existing layer, spreads (503) out and distributes the nanoparticles. The carrier fluid is evaporated leaving the residual Nanoparticles (504) in an ultrathin deposition. The layer (505) may be cured using a variety of methods including Ultraviolet light to activate a photo-initiator and or an infrared heat.

A deposition resolution is selected to ensure that the Nano Ink droplets and distributed Nanoparticles provide efficient distribution of the Nanoparticles across the pattern.

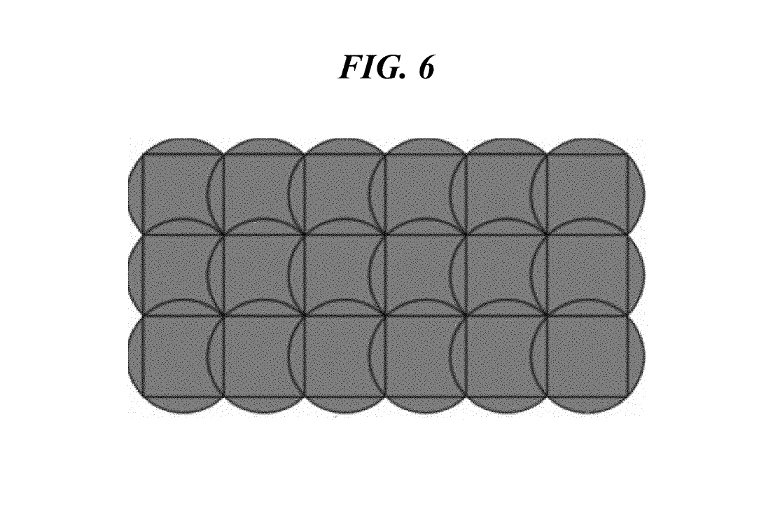

One or more deposition cycles may be applied to each pattern to ensure that the pattern is filled to the desired thickness with a cohesive covering. In FIG. 6, we illustrate examples drop patterns for inkjet deposition. In FIG. 7, we illustrate a composite material deposition.

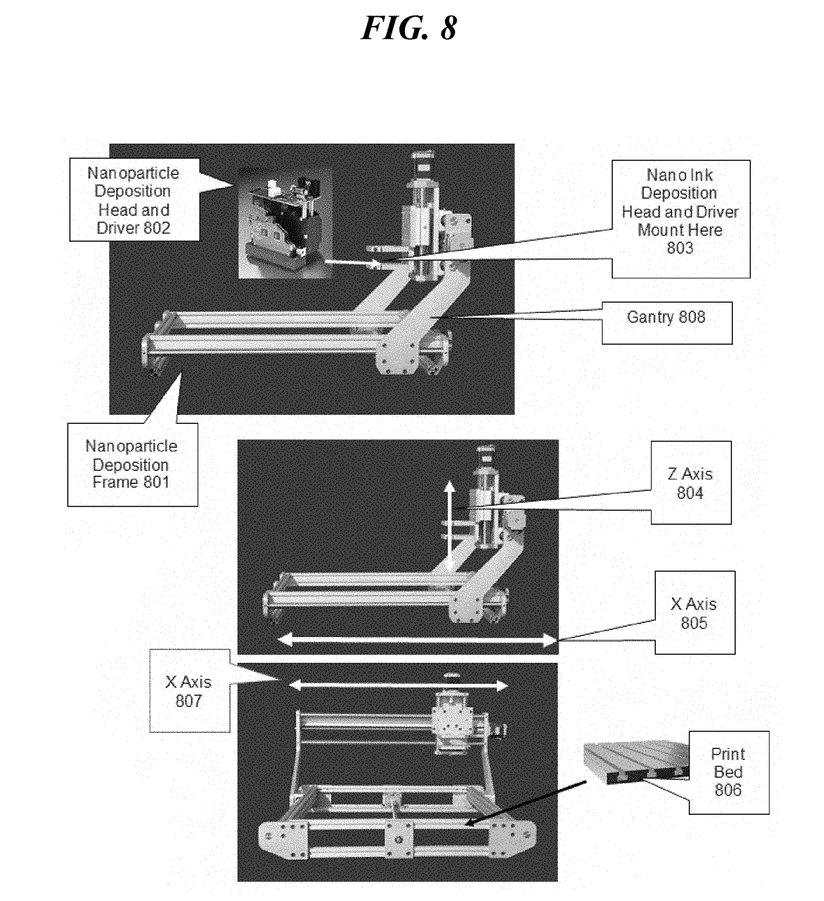

In FIG. 8 we illustrate the Nanoparticle and precursor material deposition frame. The deposition head (802) is mounted on a fixture (803) that allows for movement across the deposition bed in an X axis (805) and can allow the deposition head up or down in relation to the deposition bed Z axis (804) and allows the deposition head pitch to be altered in various directions.

The gantry (808) allows for precise X (805) and Y (807) axis movement of the deposition head across the deposition bed (806).

The movement of the gantry (808) and deposition head is accomplished through the use of stepper motors and control electronics. A power supply and communications interface are provided to interface with a computer. Remote access and control can be provided.

Optional keyboard, processor and display may enable the Nanoparticle Deposition system to be autonomous.

In FIG. 9 we illustrate the inkjet compound material deposition flow chart. Here two or more materials (901) are created as inks with a material profile that identifies the material, carrier fluid and particle loading within the ink. The inkjet compound setup processor (902) creates a profile for each material (ink) that is available for deposition.

The inkjet compound processor (905) selects the materials to be deposited as a compound based on the desired compound (903) and the profiles in the inkjet compound setup (902). The inkjet compound processor sends the following data to the print controller to identify the compound to be printed:

The ratio of each ink to be printed in the compound

The drop pattern for each ink to be printed in the compound

The drop size for each ink to be printed in the compound

The print pattern for each ink to be printed in the compound

The thickness of the printed compound

The print cycles required to meet the thickness

The drying cycles for the compound

A substrate is provided for Nanoparticle ink deposition. The substrate may have a non-stick function to allow the multilayer stack to be released from the substrate when the deposition process is completed.

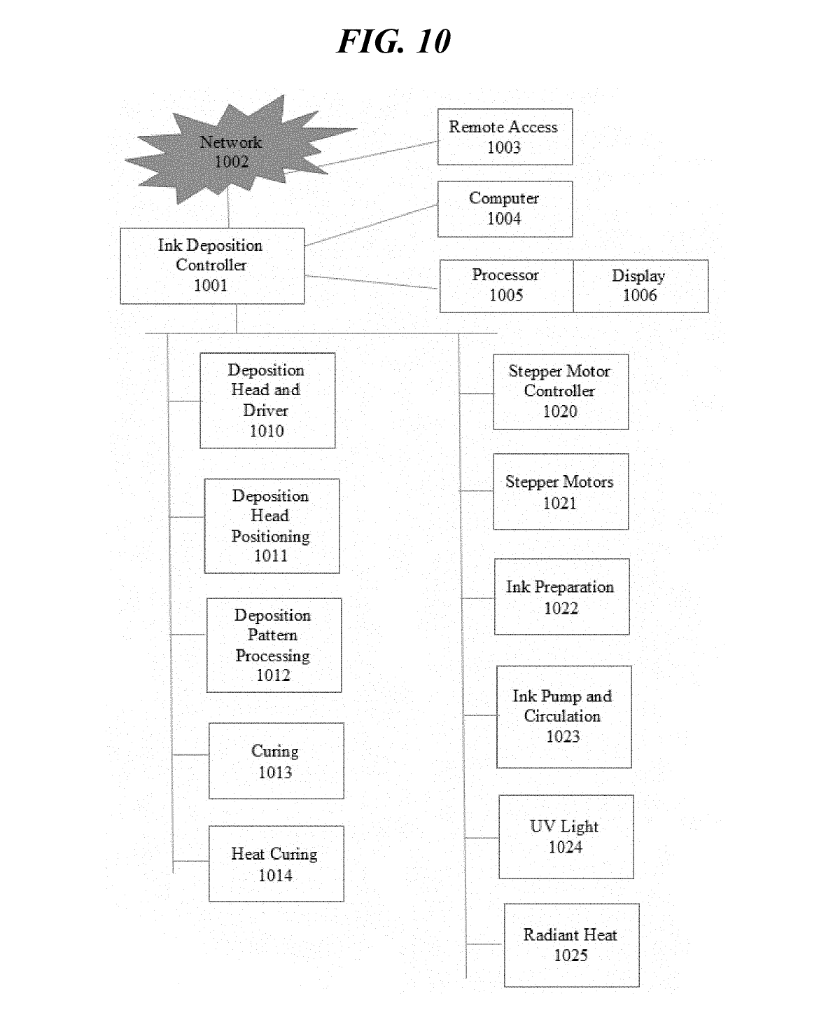

In FIG. 10 we illustrate the processes used to perform the print process for material deposition.

We use an Image Processor and Materials Deposition Profile (MDP) to identify a compound material created through the deposition of multiple materials through independent print heads to create a compound material within the layer (1005) or a computer (1004) to define the deposition patterns for material deposition, a raster image processor (RIP) and material deposition profile (MDP) creates the code to be communicated to the deposition controller (1001) to deposit the one or more types of materials in the desired pattern (1012). An example of a computer program for designing the pattern of the Nanoparticle and or precursor materials deposition is Power Point from Microsoft.

The print controller (1001) provides a high speed data path and electronics that buffer, store, manipulate and route data to the deposition head drivers (1010) in the deposition head array.

Deposition head drivers (1010) configure power and drive a deposition head and can define, create and supply the waveform pulses used by the deposition head to eject the Nanoparticle ink drops.

Deposition printing is a non-impact process. The Nanoparticle and or precursor material Ink is emitted from nozzles while they pass over the deposition bed. The operation of Nanoparticle and or precursor materials deposition includes the Nanoparticle ink in various types being squirted onto the print bed or an existing layer to build a multilayer stack.

The deposition head scans the deposition bed in horizontal strips, using the deposition head positioning system (1011) and the frame's stepper motors (1021) to drive the Y axis. A row of Nanoparticle and or precursor material ink drops are deposited then the gantry moves the deposition head (1010) into place to deposit the next strip. The deposition head (1010) may deposit a vertical row of droplets on each pass.

The deposition head (1010) takes about one half of a second to print the strip across the deposition bed. Multiple deposition heads may be applied to enable more than one ink type.

The deposition head (1010) is a “drop on demand” (DOD) device, squirting small droplets of Nanoparticle and or precursor material ink onto the deposition bed or existing layer through tiny nozzles. The amount of Nanoparticle or precursor material ink propelled through the nozzles can be configured through the Deposition head driver (1010) software.

After depositing the specified amount of one or more Nanoparticles types to form the desired pattern(s), an ultra-violet light or infrared radiation is applied (1013, 1024) is to rapidly cure the layer. This allows the repeated layers to be formed in a continuous process.

The deposition system may be connected to a network (1002) to allow remote access (1003) or connection to a computer (1004).

A multi-layer Nano particle and precursor material deposition system for the fabrication of devices comprised of multiple independent layers each with similar or independent deposition patterns that may have a mixture of materials deposited with a layer that is comprised of:

a) A frame structure that allows a print head to be moved in up to four positions including the x, y and z axis (FIG. 4) and an angle of the print head, and

b) One or more ink jet print head with nozzles configured to allow Nanoparticles and or precursor materials combined with a binder and a carrier fluid to pass through the print head and be deposited as droplets onto a print substrate or an existing printed layer, and

c) where the inkjet print head conducts one or more print cycles for each print pattern to form a layer, and

d) where the layer may be exposed to a headed print bed to reduce, and or evaporate the carrier fluid, and

e) Where consecutive independent layers may be printed on top of existing layers, and

f) Where the print head maintains a specified distance from the substrate

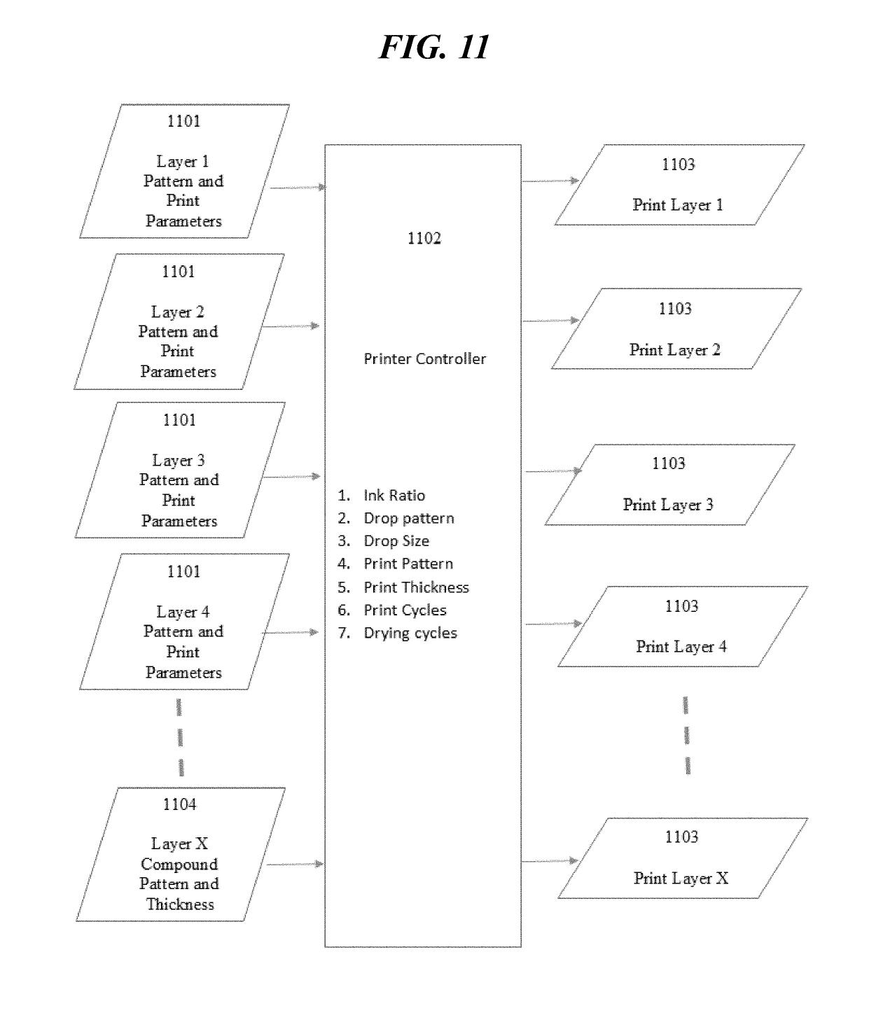

In FIG. 11 we illustrate the inkjet material deposition process. The print controller (1102) controls the ink ratio, drop pattern, drop size, printed patterns, printed thickness how many print cycles per layer, the drying of the printed layers and how many of the individual layers are printed in a configuration.

Layer one (1101) has a pattern with defined inks for each pattern in the layer. Layer two (1102) has a pattern with defined inks for each pattern in the layer and so on. The layers are printed and dried using heat and may be UC cured.

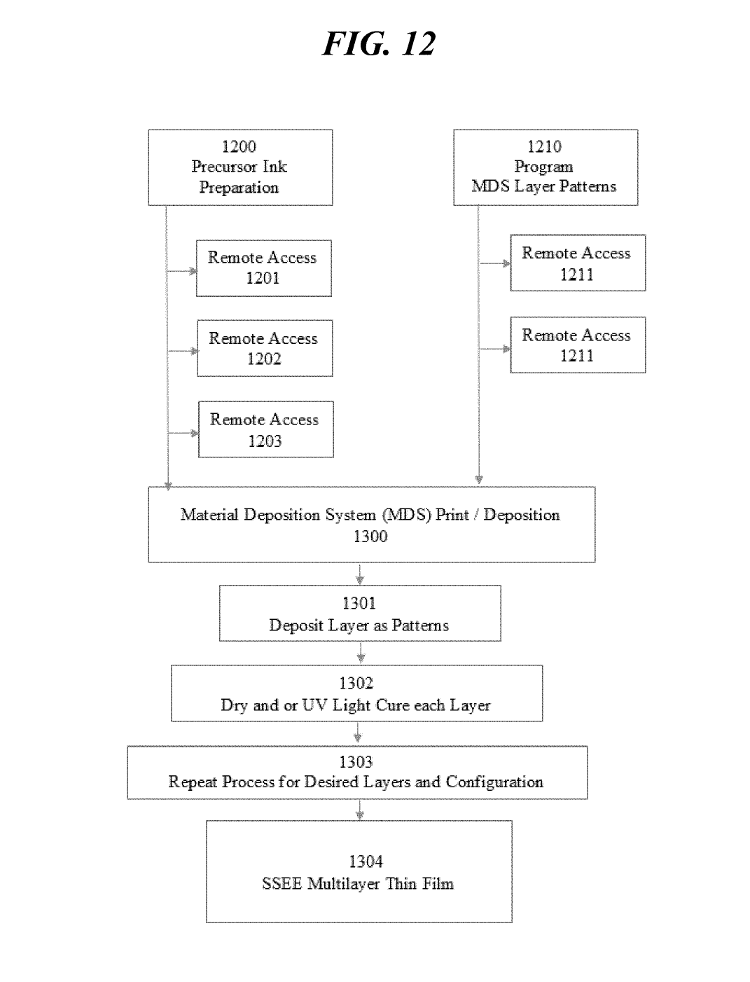

In FIG. 12, we illustrate the process of creating an Multilayer Thin Film for the Solid State Energy Element. In (1200) we create the precursor inks (1201, 1203, 1204, etc.) for each material to be deposited as patterns within the layers. In 1210, we setup the Material Deposition System to print the patterns within each of the layers.

In 1300, we use the precursor inks to print the patterns (1301) within each layer, we dry each layer (1302) and may apply UV light (1302) to cure UV monomers. We repeat this process (1303) until we have the number of layers and configuration desired for the multilayer thin film (1304).

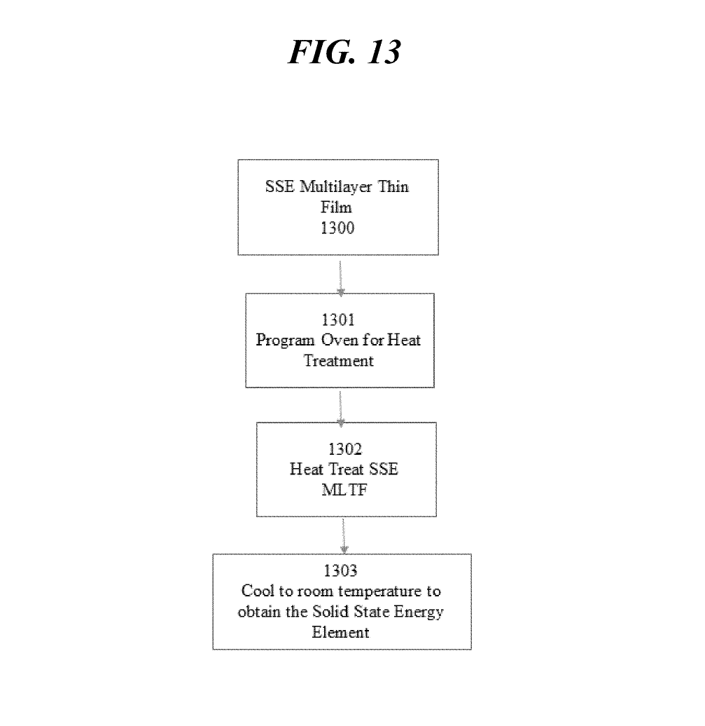

In FIG. 13, we illustrate the heat treatment for the SSEE multilayer thin film. The SSE multilayer thin films are place in an oven for heat treatment at the desired temperatures for selected duration at each temperature (1301, 1302). The heat treated multilayer thin films become a Solid State Electrolyte Energy Element upon completion of the heat treatment (1303).

The above applications do not represent the limits of the SSEE and or inkjet material deposition process, many additional applications can be envisioned.

The features and advantages described in the specification are not all inclusive, and particularly, many additional features and advantages will be apparent to one of ordinary skill in the art in view of the description, specification and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

The present subject matter can be embedded in a computer program product, which comprises all the features enabling the implementation of the methods described herein, and which—when loaded in a computer system—is able to carry out these methods. Computer program in the present context means any expression, in any language, code or notation, of a set of instructions intended to cause a system having an information processing capability to perform a particular function either directly or after either or both of the following a conversion to another language, code or, notation; and b reproduction in a different material form.

Each computer system may include, inter alia, one or more computers and at least a computer readable medium allowing a computer to read data, instructions, messages or message packets, and other computer readable information from the computer readable medium. The computer readable medium may include computer readable storage medium embodying non-volatile memory, such as read-only memory ROM, flash memory, disk drive memory, CD-ROM, and other permanent storage. Additionally, a computer medium may include volatile storage such as RAM, buffers, cache memory, and network circuits. Furthermore, in certain embodiments of the computer readable medium, other than a computer readable storage medium as discussed above, the computer readable medium may comprise computer readable information in a transitory state medium such as a network link and/or a network interface, including a wired network or a wireless network, that allow a computer to read such computer readable information.

Although specific embodiments of the subject matter have been disclosed, those having ordinary skill in the art will understand that changes can be made to the specific embodiments without departing from the spirit and scope of the disclosed subject matter. The scope of the disclosure is not to be restricted, therefore, to the specific embodiments, and it is intended that the appended claims cover any and all such applications, modifications, and embodiments within the scope of the present disclosure.

1. A Solid-State Energy Element (SSEE) providing energy storage comprised of one or more SSEE(s), where each of the SSEE comprises:
a. A solid state electrolyte layer including solidified, superionic conductor, precursor ink, the solid state electrolyte layer having a thickness that is less than, or equal to, 10 microns thick, reducing the ion transport path between the electrodes; and
b. Where ion transport across the electrolyte layer is improved based on a shorter ion pathway between the electrodes by reducing the solid state electrolyte layer thickness; and
c. Where the one or more solid state electrolyte layers have insulating material applied around the outer edges; and
d. Where the solid state electrolyte layers are interleaved in between electrode layers to form a multi-layer thin film, and
e. Where the top and bottom electrodes are cathodes and anodes; and
f. Where the electrodes within the stack are bidirectional cathodes and or bidirectional anodes.

2. The SSEE of claim 1, where one or more layers are comprised of complex patters of one or more materials.

3. The SSEE of claim 1, wherein all the layers are stacked directly on and contacting each other forming a multi-layer thin film of greater than or equal to 100 layers.

4. The SSEE of claim 1, wherein all the layers are stacked directly on and contacting each other forming a multi-layer thin film of greater than or equal to 1,000 layers.

5. The SSEE of claim 1, wherein all the layers are stacked directly on and contacting each other forming a multi-layer thin film of greater than or equal to 2,000 layers.

6. The SSEE of claim 1, wherein the dielectric layers are deposited in ultra-thin less than one micron thickness to increase overall capacitance of the SSEE device.

7. The SSEE of claim 1, wherein the dielectric layers are deposited in ultra-thin less than one micron thickness to increase overall capacitance of the SSEE device.

8. The SSEE of claim 1, where the electrode layers is a sodium ion based electrolyte and
a. Where the inner electrodes are smaller in width and length than the energy layer to avoid contact with other electrodes, except where connected to an electrode array collector that forms an outer electrode, and
b. Where insulator material is applied to the outer edges of each left and right electrodes, except where connected to the collector, to avoid potential interaction between the left and right electrodes and to eliminate an electrical path between energy layers, and
c. Where the inner left and inner right inner electrodes are each combined into a left and right collector that forms the outer left and right electrode.

9. The SSEE of claim 1, where the individual electrodes, within the SSEE, act as a safety fuse to disconnect upon high heat, high voltage or high amperage.

10. A method of fabrication of a Solid State Energy Element using inkjet material deposition printing comprising:
a. Preparation of an electrode material deposition solution that is used as an ink in an inkjet printer,
b. Preparation of a solid state electrolyte solution that is used as an ink in an inkjet printer to produce the solid state electrolyte layer;
A precursor solution of a solid state electrolyte material may be synthesized as a printable ink; and
Nanoparticles may be suspended in the precursor solution, and
c. Preparation of an insulator material in solution that is used as an ink in an inkjet printer to produce the insulator layer by an insulator ink.
d. SSEE Thin Film
The electrode layer ink, dielectric layer ink and the optional insulator ink are applied as layers to form an SSEE thin film as follows:
i. The base layer is formed by printing an insulator pattern with insulator ink
ii. The first electrode layer is formed by printing the cathode or anode layer pattern with cathode ink.
iii. A solid state electrolyte layer is formed by printing the solid state electrolyte ink
iv. An optional insulator is printed around the edges of the solid state electrolyte layer using insulator ink.
v. A bi-directional anode layer is formed by printing a pattern with anode ink
vi. An optional insulator may be applied around the edges of the anode layer and or cathode layer except for the side where the anode is attached to an anode collector.
vii. A bi-directional cathode layer is formed by printing a pattern with anode ink.
viii. A solid state electrolyte layer is formed by printing the solid state electrolyte ink
ix. An optional insulator is printed around the edges of the solid state electrolyte layer using insulator ink.
x. This process is repeated with solid state electrolyte layers interleaved in between the electrode layers until the desired number of layers are achieved
xi. The top electrode is an anode layer formed printing an anode pattern with anode ink
xii. The top layer is formed printing an insulator pattern with insulator ink
e. Heat Treatment of unified SSEE Thin Film
Where one or more unified multilayer thin film(s) are combined and heat treated in specific stages to ensure Nanoparticles in each layer remain in place as the multilayer thin film is cured, calcined and sintered:

11. The method of fabrication of claim 10, wherein one or more heat treatments of the SSEE particles, and or dielectric layer, and or multilayer thin film utilizes a reduced oxygen atmosphere to reduce and or eliminate oxidation during the heat treatments.

12. The method of fabrication of claim 10, used to fabricate an electronic circuit comprised of single and multilayer devices.

13. The method of fabrication of claim 10, used to fabricate a multilayer electronic device, a circuit pattern and or a battery.
